(19) United States
(12) Patent Application Publication
(10) Pub. No.: US 2013/0120385 A1
(43) Pub. Date: May 16, 2013

(54) Methods and Apparatus for Diffuse Indirect Illumination Computation using Progressive Interleaved Irradiance Sampling

(71) Applicants: Aravind Krishnaswamy, San Jose, CA (US); Gavin S.P. Miller, Los Altos, CA (US); Lei Yang, Kowloon (CN)

(72) Inventors: Aravind Krishnaswamy, San Jose, CA (US); Gavin S.P. Miller, Los Altos, CA (US); Lei Yang, Kowloon (CN)

(21) Appl. No.: 12/854,785

(22) Filed: Aug. 11, 2010

Related U.S. Application Data
(60) Provisional application No. 61/242,692, filed on Sep. 15, 2009.

(51) Int. Cl. G06T 15/50

(52) U.S. Cl. 345/426

(57) ABSTRACT

Methods and apparatus for diffuse indirect illumination computation using progressive interleaved irradiance sampling. Embodiments may implement a method that amortizes the cost of computing the irradiance integral for diffuse indirect illumination both temporally and spatially in screen space. For each pixel, only one secondary ray is fired. By carefully arranging different secondary ray directions for different pixels according to a sampling sequence, embodiments may filter the noisy estimate so that each pixel receives a relatively uniform coverage of the integrated hemisphere. Some embodiments may use a bilateral filter so that the geometric discontinuities are respected. The sequence may continue to a higher-level of stratification in each frame. This ensures that the rendering is converging to a noise-free result.

### PRIORITY INFORMATION

This application claims benefit of priority of U.S. Provisional Application Ser. No. 61/242,692 entitled “Methods and Apparatus for Diffuse Indirect Illumination Computation using Progressive Interleaved Irradiance Sampling” filed Sep. 15, 2009, the content of which is incorporated by reference herein in its entirety.

### BACKGROUND

### Description of the Related Art

Three-dimensional (3-D) computer graphics is concerned with digitally synthesizing and manipulating 3-D visual content. In 3-D computer graphics, global illumination rendering is a method that attempts to capture the way in which light interacts in the real world. Global illumination algorithms generally take into account the light that comes directly from a light source (direct illumination), and also light rays from the same source reflected by other surfaces in the scene (indirect illumination). The results achieved by global illumination rendering processes may produce more photo-realistic synthesized or manipulated images.

Conventional global illumination rendering methods are computation-intensive and time-consuming processes, and are thus typically used for off-line rendering rather than in real-time image generation, for example in computer-generated imagery (CGI) applications. Computer-generated imagery (CGI) is the application of the field of computer graphics in various media including, but not limited to: films, television programs, commercials, simulators and simulation generally, and printed media. CGI images are typically produced “off-line”; that is, not in real-time.

Irradiance computation may be performed in a 3-D image rendering process in order to capture global illumination effects such as diffuse inter-reflection (color bleeding). Irradiance computation is widely used in 3-D computer graphics to generate realistic looking images.

Ray tracing is a general technique from geometrical optics for modeling the paths taken by light as it interacts with optical surfaces. To perform global illumination rendering, rays may be fired from a perspective point, for example starting at the bottom of the scene. FIG. 1A illustrates the firing of rays at an example image. The rays 106 may be fired from the perspective point 104 of a “viewer” of the scene 100. Light sources 102A and 102B show the approximate location of light sources in scene 100. Conventionally, for each pixel, or point, in the scene 100, a ray 106 is fired into the pixel. Each time a ray 106 hits a point on a surface in the scene 100, for example point 108, direct radiance, i.e. light received at the point directly from a light source, may be calculated for the point. If diffuse inter-reflection, or indirect irradiance, is being determined, light from a light source (as well as light reflected off another surface) may be assumed to “bounce” off a surface in the scene and hit points on other surfaces in the scene, and thus an indirect radiance value for the point is calculated according to the light that reaches the point indirectly from one or more other surfaces. FIG. 1B illustrates point 108 of FIG. 1A with several example direct light sources and indirect light sources.

In order to calculate diffuse inter-reflection, an irradiance calculation is conventionally performed at every point on surfaces that are mapped to the screen. The irradiance calculation is conventionally performed by casting and integrating many rays, or “samples”, over a hemisphere at each point on a surface that is mapped to the screen. FIG. 1C illustrates the casting of example sample rays at point 108 of the scene 100 from FIGS. 1A and 1B when performing an irradiance calculation for the point. Using conventional brute-force methods, if too few rays are cast at a point, the resulting irradiance calculation may have a high amount of noise, which is undesirable; if too many rays are cast, the irradiance calculation can be very computationally expensive.

### Interleaved Sampling

Interleaved sampling has been used in interactive global illumination tasks. In one such approach, the whole incoming radiance field is represented by a set of virtual point lights (VPLs). To perform the integration, each pixel in a regular pattern (3×3, for example) uses a different set of light samples. The VPL contributions for each pixel are then filtered and combined with its neighborhood using a discontinuity buffer. This technique can be viewed as sharing shading tasks across neighboring pixels.

### Irradiance Cache

Irradiance cache is a method to accelerate the computation of diffuse indirect illumination in global illumination systems. This acceleration is achieved by computing the precise indirect illumination only at sparse points in the image, and interpolating the rest of the image using the previously calculated points. The result of irradiance cache is very sensitive to the sampling distribution/sequence and the interpolation method. It is also a relatively expensive method since the samples are stored and accessed in a hierarchical spatial data structure, such as an octree.

### Irradiance Filtering

Irradiance filtering applies a spatially variant low-pass filter to the rendered image in order to reduce the noise of Monte-Carlo integral with a relatively small number of samples. Similar to the irradiance cache, this method assumes that the irradiance signal is relatively smooth and slow varying, i.e. is dominated by low frequency components. By filtering out the high-frequency noise in the irradiance signal, it will also remove the noise caused by insufficient samples. Unfortunately, in conventional irradiance filtering methods, unless a very large filter is used, low-frequency noise can still persist in the result, causing visible blotchy artifacts. While a larger filter could potentially reduce this artifact, it may also introduce more bias in the shading, and may be more computationally expensive.

### Low-Discrepancy Sampling Sequence

The task of Monte-Carlo simulation requires relatively even-distributed samples across the sampled space. A uniformly random sequence typically does not provide the best variance reduction, so various deterministic quasi-random sampling sequences have been introduced. Examples of these sequences include the Halton sequence and the Sobol sequence. There are also variations of these sequences at different dimensions. While these sequences are proved to have low discrepancy, i.e. any window in the space of the same size covers roughly the same number of samples, their sub-sequences do not necessarily have this nice property.

### SUMMARY

Various embodiments of methods and apparatus for diffuse indirect illumination computation using progressive interleaved irradiance sampling are described. Conventionally, computing the irradiance integral for diffuse indirect illumination is computationally expensive. Embodiments may implement a method that amortizes this cost both temporally and spatially in screen space, achieving better quality. In the ray tracing shader, for each pixel, only one secondary ray is fired. By carefully arranging different secondary ray directions for different pixels according to a sampling sequence, embodiments may filter the noisy estimate so that each pixel receives a relatively uniform coverage of the integrated hemisphere. Some embodiments may use a bilateral filter so that the geometric discontinuities are respected. The sequence may continue to a higher-level of stratification in each frame. This ensures that the rendering is converging to a noise-free result.

In embodiments of a global illumination rendering method using a non-adaptive diffuse indirect illumination method, an incremental image may be computed using one secondary ray per pixel. A progressive interleaved irradiance sampling method may be used with or in a shader to determine where to fire a secondary ray at each pixel at each iteration. At each iteration, the incremental image may be blended with an accumulation image or buffer. The process iterates until a stopping criterion is met. For example, in some embodiments, a user may stop the rendering when displayed results (the current content of the accumulation buffer) are satisfactory. As another example, a parameter or constant may indicate a maximum number of iterations to be performed.

In some embodiments, to compute the incremental image, for each pixel, one secondary ray is fired, for example according to a progressive interleaved irradiance sampling method. Direct illumination, surface diffuse color, irradiance, surface depths and normals are computed at each pixel according to the fired secondary ray. The surface depths and normals are used to filter the irradiance values according to a bilateral filter. In some embodiments, a joint-bilateral filter may be used. In some embodiments, the kernel size of the bilateral filter may be decreased over iterations; that is, the size of the filter may be reduced over time. The filtered irradiance values may be multiplied with the diffuse color, and the results combined with the direct illumination to produce the incremental image.

In some embodiments, to blend the incremental image with the accumulation buffer, blending weights may be computed based on the iteration number. The blending weights may then be used to blend the incremental image with the contents of the accumulation buffer.

In embodiments of a global illumination rendering method using an adaptive diffuse indirect illumination method, the image is processed in blocks. All the blocks are initialized to active. An incremental image may be computed using one secondary ray per pixel. The image is processed by blocks; blocks for which processing has been stopped on a previous iteration are not processed. A progressive interleaved irradiance sampling method may be used with or in a shader to determine where to fire a secondary ray at each pixel at each iteration. At each iteration, the incremental image may be blended with the accumulation image or buffer. In some embodiments, only blocks that were processed during the current iteration are blended. The termination criterion for each block is computed, and block states may be changed from active to satisfied accordingly. The state of satisfied blocks is checked; a block may be changed from satisfied to stopped if the block and its neighbor blocks (e.g., its eight adjacent blocks) are all satisfied or stopped. The process iterates until a stopping criterion is met. For example, in some embodiments, a user may stop the rendering when displayed results (the current content of the accumulation buffer) are satisfactory. As another example, a parameter or constant may indicate a maximum number of iterations to be performed. As another example, the process may stop when all blocks are marked as stopped.

### BRIEF DESCRIPTION OF THE DRAWINGS

FIG. 1A illustrates the firing of rays at an example image or scene.

FIG. 1B illustrates a point in a scene with several example direct light sources and indirect light sources.

FIG. 1C illustrates the casting of example sample rays at a point in a scene when performing an irradiance calculation for the point.

FIGS. 2A through 2D show example sampling sequences that may be used in some embodiments.

FIG. 3 shows an example synthesized image for which shading is to be rendered.

FIG. 4 illustrates data flow in a global illumination rendering method using a progressive interleaved irradiance sampling method according to some embodiments.

FIG. 5 graphically illustrates mapping a B₀×B₀ grid of screen pixels onto B₀×B₀ regions of a hemisphere, according to some embodiments.

FIGS. 6A through 6C show a comparison of results of a conventional brute-force method for calculating irradiance that fires many secondary rays at each point and results of a method that includes diffuse indirect illumination computation using progressive interleaved irradiance sampling.

FIGS. 7A and 7B and FIGS. 8A and 8B compare results, after the same amount of time, of a conventional brute-force method for calculating irradiance that fires many secondary rays at each point with results of a method that includes diffuse indirect illumination computation using progressive interleaved irradiance sampling.

FIG. 9 is a high-level flowchart of a global illumination rendering method using a non-adaptive diffuse indirect illumination method, according to some embodiments.

FIG. 10 is a flowchart of a method for computing an incremental image using one secondary ray per pixel, according to some embodiments.

FIG. 11 is a flowchart of a method for blending an incremental image with an accumulation image, according to some embodiments.

FIG. 12 is a flowchart of a global illumination rendering method using an adaptive diffuse indirect illumination method, according to some embodiments.

FIG. 13 illustrates an example global illumination rendering module that may implement a global illumination rendering method that includes a method for diffuse indirect illumination computation using progressive interleaved irradiance sampling, according to embodiments.

FIG. 14 illustrates an example computer system that may be used in embodiments.

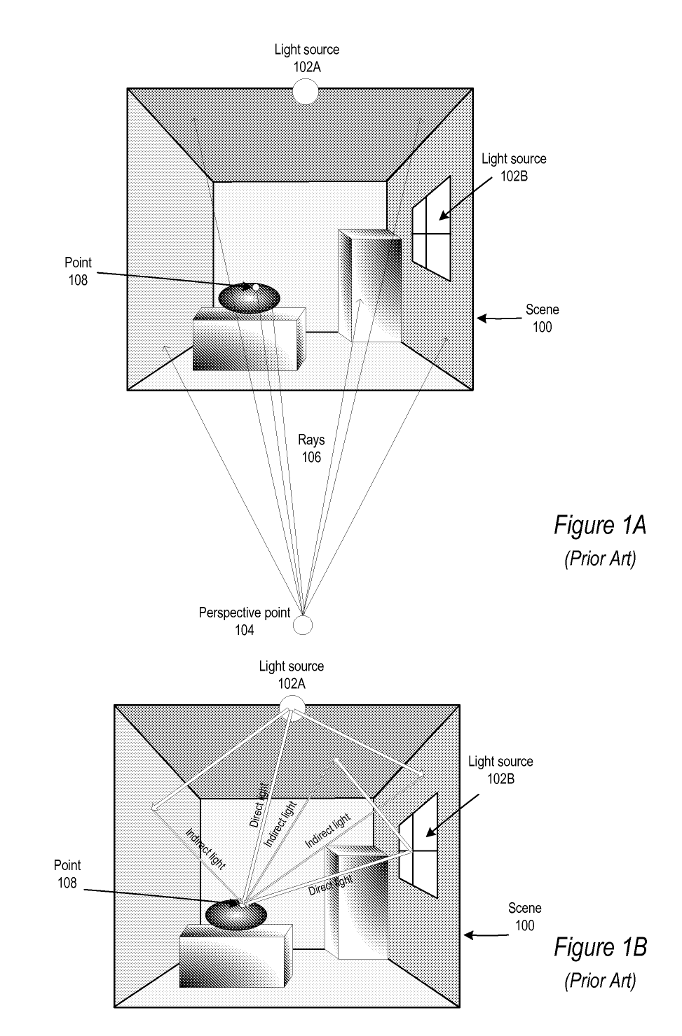

While the invention is described herein by way of example for several embodiments and illustrative drawings, those skilled in the art will recognize that the invention is not limited to the embodiments or drawings described. It should be understood, that the drawings and detailed description thereto are not intended to limit the invention to the particular form disclosed, but on the contrary, the intention is to cover all modifications, equivalents and alternatives falling within the spirit and scope of the present invention. The headings used herein are for organizational purposes only and are not meant to be used to limit the scope of the description. As used throughout this application, the word “may” is used in a permissive sense (i.e., meaning having the potential to), rather than the mandatory sense (i.e., meaning must). Similarly, the words “include”, “including”, and “includes” mean including, but not limited to.

### DETAILED DESCRIPTION OF EMBODIMENTS

In the following detailed description, numerous specific details are set forth to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter.

Some portions of the detailed description which follow are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and is generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

Various embodiments of methods and apparatus for diffuse indirect illumination computation using progressive interleaved irradiance sampling are described. Non-adaptive and adaptive embodiments of the methods for progressive interleaved irradiance sampling may be provided. Conventionally, computing the irradiance integral for diffuse indirect illumination is computationally expensive. Embodiments may implement a method that amortizes this cost both temporally and spatially in screen space, achieving better quality in a progressive ray tracer. Embodiments may assume that the diffuse indirect illumination across a surface is smooth and slow-varying. In the ray tracing shader, for each pixel, only one secondary ray is fired. By carefully arranging different secondary ray directions for different pixels according to a sampling sequence, embodiments may filter this noisy estimate in such a way that each pixel receives a relatively uniform coverage of the integrated hemisphere. Unlike conventional methods, embodiments may not introduce low frequency noise that may cause blotchy artifacts that are hard to eliminate. Some embodiments may use a bilateral filter so that the geometric discontinuities are respected. The sequence may continue to a higher-level of stratification in each frame. This ensures that the rendering is converging to a noise-free result. Embodiments of the method fit well into a progressive ray-tracing framework, achieving better results than conventional brute-force solutions in an equal time comparison.

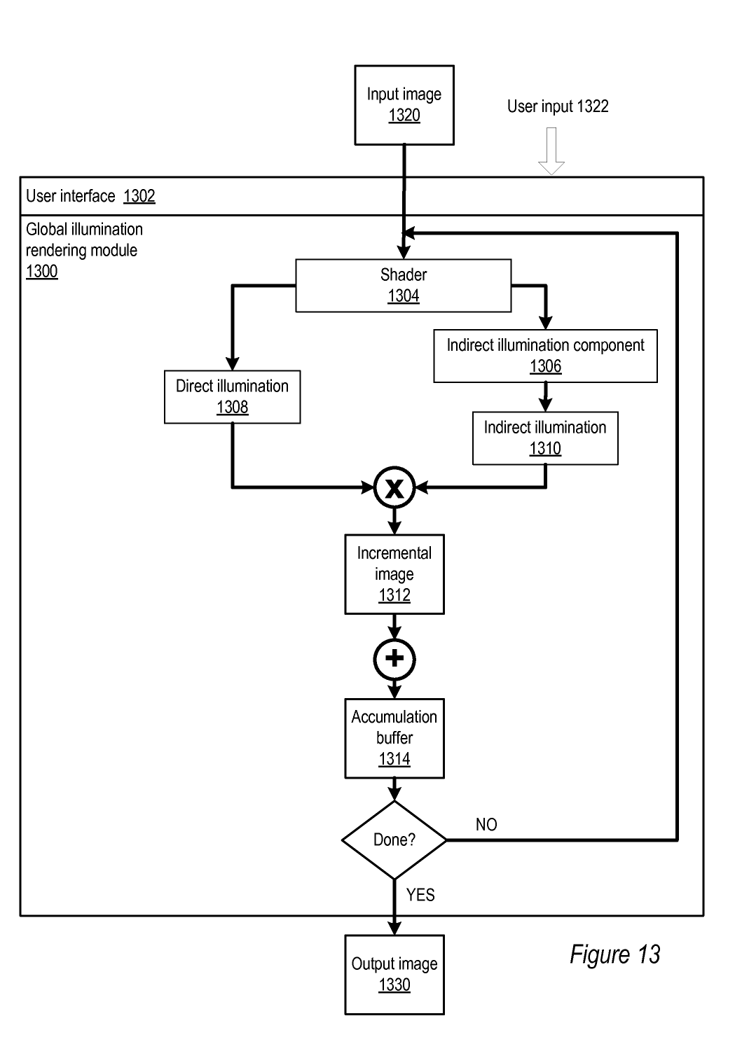

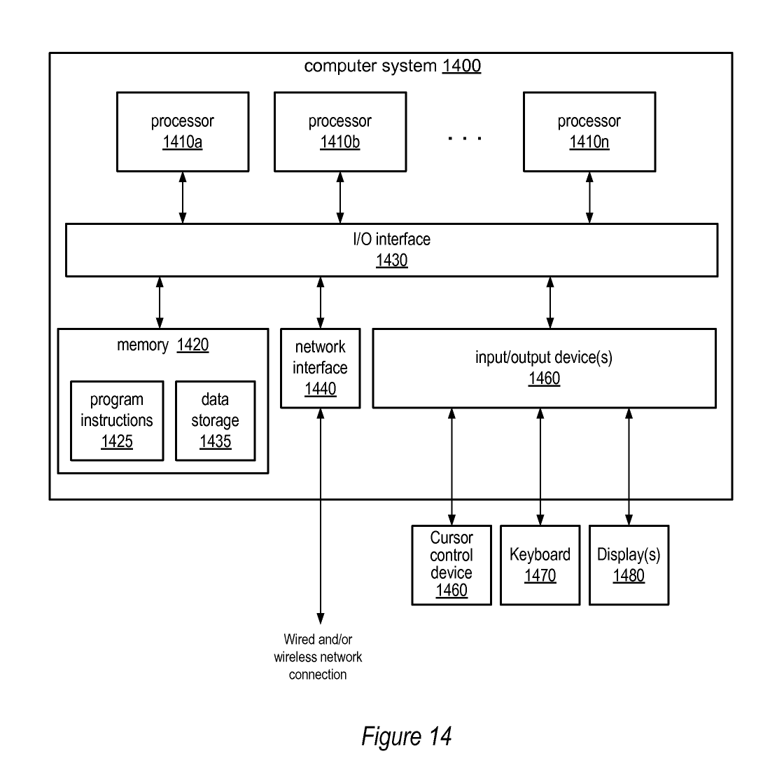

Embodiments of the methods for diffuse indirect illumination computation using progressive interleaved irradiance sampling as described herein may be performed by a global illumination rendering module implemented by program instructions stored in a computer-readable storage medium and executable by one or more processors (e.g., one or more CPUs or GPUs). Embodiments of a global illumination rendering module may, for example, be implemented as a stand-alone application, as a module of an application, as a plug-in for applications including image processing applications, and/or as a library function or functions that may be called by other applications such as image processing applications. Embodiments of the global illumination rendering module may be implemented in any image processing application, including but not limited to Adobe®PhotoShop® and Adobe® After Effects®. “Adobe”, “Photoshop”, and “After Effects” are either registered trademarks or trademarks of Adobe Systems Incorporated in the United States and/or other countries. An example global illumination rendering module that may implement the methods for diffuse indirect illumination computation as described herein is illustrated in FIG. 13. An example system on which a global illumination rendering module may be implemented is illustrated in FIG. 14.

### Incremental Stratified Grid Sampling

Embodiments may implement an incremental stratified grid sampling technique that provides at least the features of:
Overall uniformity. The samples provide good coverage of the space without clustering or holes.
Sub-sequence uniformity. For a sequence of length n, any sub-sequence of the sequence of length i (i<n) also has a relatively uniform coverage of the space.
Irregularity. Any short sub-sequence of the entire sequence does not demonstrate a strong grid pattern so as to avoid aliasing.

### Single-Level Stratified Grid Sampling

Consider a 2-dimensional n×n lattice grid structure, which may be referred to as a base n grid. The grids may be labeled in a sequential row major pattern, starting from the upper-left grid. The label, denoted as L (0<L<n²−1), allows arbitrary grid positions to be addressed. A simple scan-line sampling sequence can then be written recursively as:

Lᵢ₊₁ⁿ=(Lᵢⁿ+1)mod n² (1)

where Lᵢ is the label of the ith sample in a base n sequence. Apparently, Lᵢ has good overall uniformity, but fails to provide any sub-sequence uniformity. To improve the sub-sequence uniformity, variations to the increment may be introduced at each sample by using a predefined sequence Cᵢ(0<i<n²):

Lᵢ₊₁ⁿ=(Lᵢⁿ+C_{i mod n}_{²}ⁿ)mod n² (2)

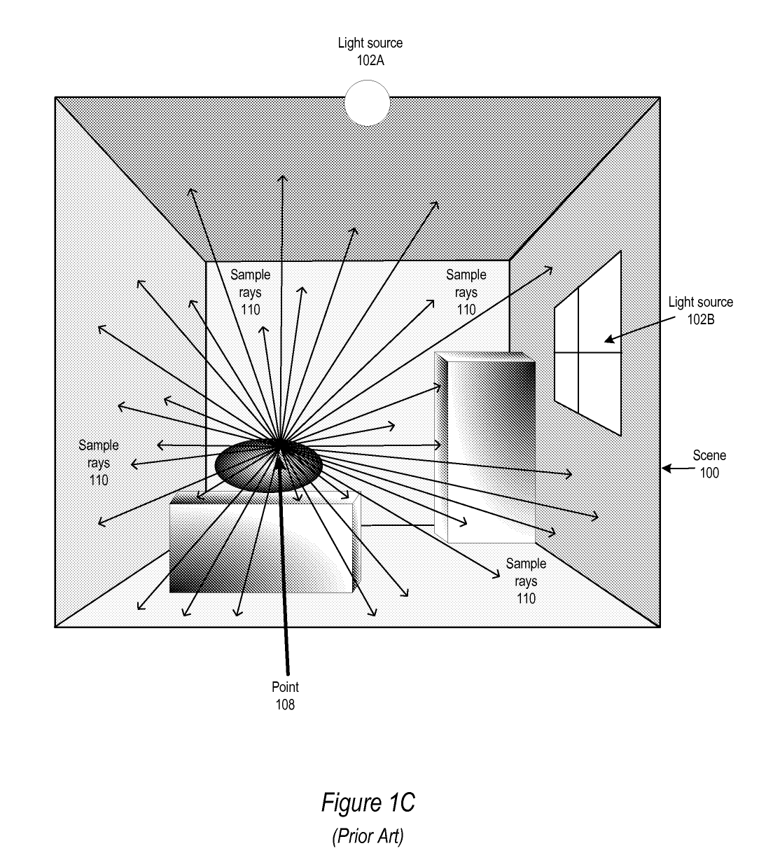

The sequence C₁ⁿ may be selected so that the period of the resulting sequence is the same as its length. It should also ensure the sub-sequence uniformity of the resulting sequence. FIGS. 2A through 2D show example sampling sequences that may be used in some embodiments. FIG. 2A shows an example sample sequence of size 4; FIG. 2B shows an example sample sequence of size 9; FIG. 2C shows an example sample sequence of size 16; and FIG. 2D shows an example sample sequence of size 25. The numbers in each of the grids of FIGS. 2A through 2D indicates i.

In some embodiments, for some small number of n, Cᵢⁿ may be set as a constant. For example, for n=5, Cᵢ⁵=18 produces a desirable sequence with sub-sequence uniformity at all levels. Such special cases may further reduce the time for generating new samples.

Alternatively, equation (1) may be rewritten in non-recursive form as:

Lᵢⁿ=\tilde{C}_{i mod n}_{²}ⁿ (3)

where:

$${\tilde{C}}_{k}^{n} = {\sum }_{i = 0}^{k} {C}_{i}^{n} mod {n}^{2} \qquad ( 4 )$$

If the sampled space is parameterized as [0; 1]×[0; 1], the coordinate of the ith sampling point in a base n grid can be written as:

$${P}_{i}^{n} = ( ⌊ \frac{{L}_{i}}{n} ⌋ \cdot \frac{1}{n} , {L}_{i} mod n \cdot \frac{1}{n} ) \\ {\hat{P}}_{i}^{n} = {P}_{i}^{n} + ( \frac{0.5}{n} , \frac{0.5}{n} ) \qquad ( 5 )$$

in which Pᵢⁿ is the upper left corner of a grid, and \hat{P}ᵢⁿ is the center of a grid. Both Lᵢⁿ and Pᵢⁿ can be precomputed and stored in arrays to reduce the amount of real-time computation.

### Hierarchical Grid Sampling

Typically, Monte-Carlo integration requires hundreds or thousands of samples. It may become tedious and difficult to generate sequences for large sampling grids by hand. Embodiments may employ a hierarchical sampling technique to ease this process.

In some embodiments of the hierarchical sampling technique, in each dimension, the fine grid is broken into p levels hierarchically. Each lower level cell contains the grid of the next level. The base of each level is different and they are coprime to each other. Two integers are coprime if they have no common positive factor other than 1 or, equivalently, if their greatest common divisor is 1.

Some embodiments, to obtain both the properties of sub-sequence uniformity and irregularity, may advance in the sequences of all the levels when generating the samples. Intuitively, changing position in lower levels (larger scale) helps to achieve sub-sequence uniformity, while changing position in higher levels (smaller scale) helps to generate irregularity.

To be precise, the coordinate of the ith sample in a hierarchical grid sample sequence with bases {Bᵢ, 0≦i≦p} can be written as:

$${H}_{i}^{p} = {\sum }_{k = 0}^{p} ( {P}_{i}^{{B}_{k}} \cdot {\prod }_{j = 0}^{k - 1} \frac{1}{{B}_{j}} ) \\ {\hat{H}}_{i}^{p} = {H}_{i}^{p} + ( 0.5 , 0.5 ) \cdot {\prod }_{j = 0}^{p} \frac{1}{{B}_{j}} \qquad ( 6 )$$

If the set {Bᵢ} satisfies the mutually coprime condition, then the total length of sequence Hᵢ^{p} is:

$$s = {( {\prod }_{i = 0}^{p} {B}_{i} )}^{2} \qquad ( 7 )$$

That is Πᵢ₌₀^{p}Bᵢ grids per axis. The coprime condition ensures that all the positions in the grid are iterated.

Embodiments of the hierarchical sampling technique may be used to provide an easy way to generate long sequences, and may also help to reduce the size of storage and improve efficiency.

### Irradiance Filtering

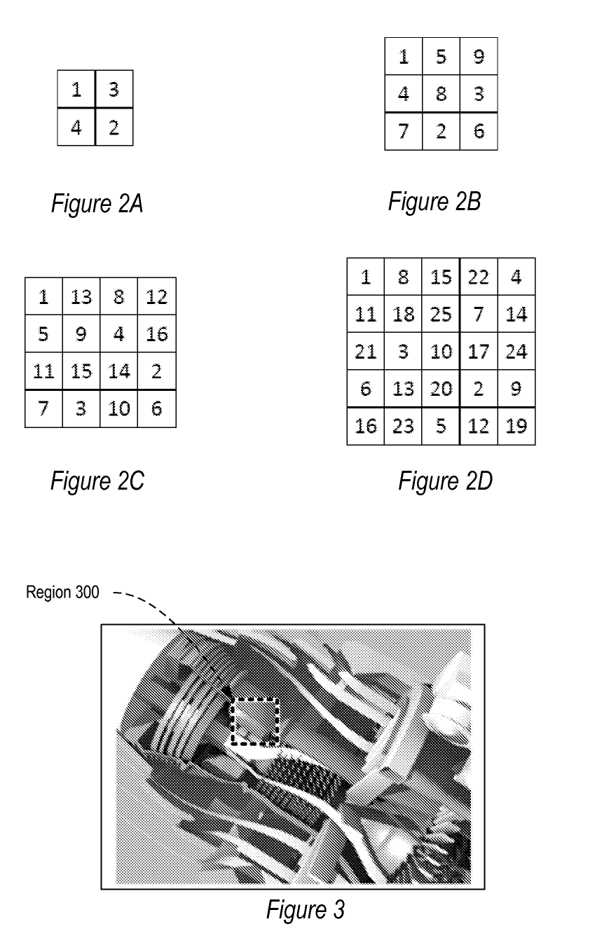

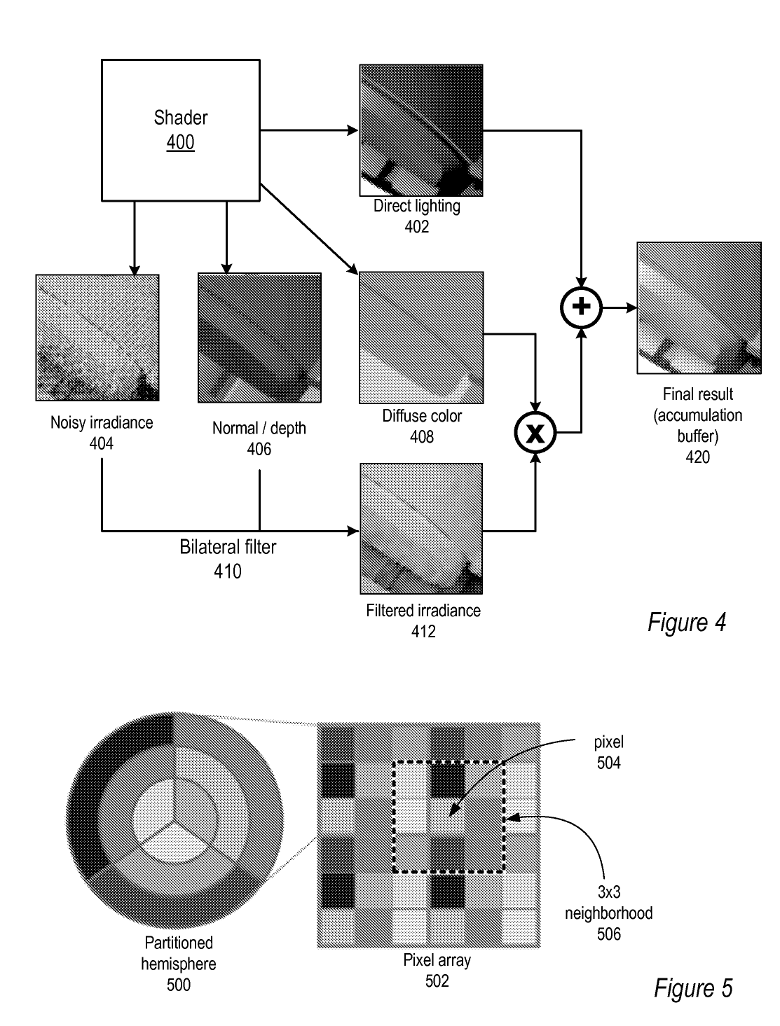

FIG. 4 illustrates data flow in a global illumination rendering method using a progressive interleaved irradiance sampling method according to some embodiments. FIG. 3 shows an example synthesized image for which shading is to be rendered; the dashed black square indicates an example region 300 being processed in FIG. 4.

### Splitting the Shading Function

In FIG. 4, in the shader 400, the final color may be separated into several components: diffuse interreflection, and other components (e.g., ambient, specular and other direct illumination effects—in other words, the direct lighting 402). When shading a ray, the diffuse interreflection result is stored in a separate (irradiance) buffer 404. Surface normals and depths 406 and diffuse color 408 are also generated by the shader 400. In some embodiments, the rest of the components (direct lighting 402) are added to the accumulation buffer 420 as usual. After being filtered in a separate pass in which irradiance 404 and normal/depth 406 are processed according to a bilateral filter to generate filtered irradiance 412, which is then multiplied by the diffuse color 408, the irradiance results are then added to the accumulation buffer 420. Alternatively, in some embodiments, the filtered irradiance 412 (the indirect lighting) and the direct lighting 402 may be combined and then blended into the accumulation buffer 420.

### Sampling

The conventional brute-force approach to irradiance calculation is to sample the entire hemisphere for each pixel and calculate the Monte-Carlo integration for the irradiance value. Typically, this requires tracing hundreds or even thousands of secondary rays for each pixel, which is prohibitively expensive even in off-line rendering tasks. Embodiments may amortize this cost, both temporally and spatially, in screen space.

Some embodiments may use a hierarchical grid sampling technique such as described above to complete the sampling for each pixel. In some embodiments, the first level of stratification is not only temporally, but is also spatially, amortized. In some embodiments, a strategy similar to interleaved sampling may be used. Assume the base number of the first level is B₀. The hemisphere is partitioned into B₀×B₀ stratified regions by equally dividing the hemisphere in the spherical coordinate system. The final pixel array is also divided into tiles of size B₀×B₀ pixels. Each tile is then mapped to an entire hemisphere, with each pixel in the tile assigned to a unique stratified region. The following may be used to denote the individual regions on the hemisphere:

S_{i,j}(0≦i,j<B₀)

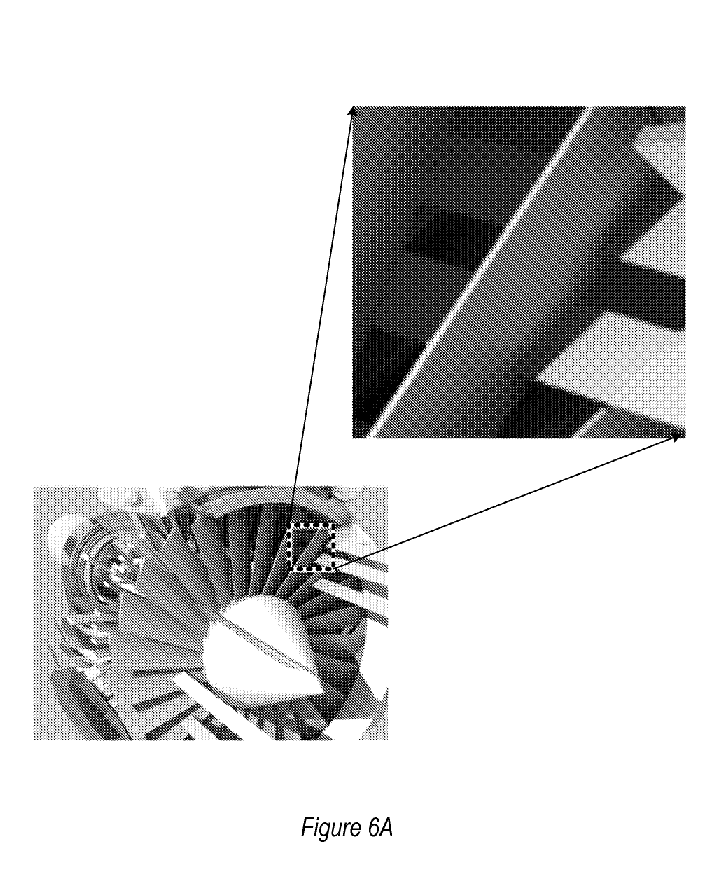

T(x, y) may be used to represent the pixels in a tile. FIG. 5 graphically illustrates this process according to some embodiments. FIG. 5 shows a 3×3 example 506 of the sampling method. In FIG. 5, the partitioned hemisphere 500 is mapped to tiles in the pixel array 502. Each pixel samples one region in an interleaved manner. To gather samples for the entire hemisphere 500 for a particular pixel 504, some embodiments may sum up the pixel's 3×3 neighborhood 506, shown as a black-and-white dashed square.

Assume that the entire shaded area is filled with a flat surface. In the filtering pass, each pixel is substituted by an average of its B₀×B₀ neighborhood. If the tiles are all mapped to the hemisphere in the same way, it can be seen that any B₀×B₀ window covers all the stratifications of the hemisphere. Hence, each pixel receives a relatively uniform integral of the irradiance.

In some embodiments, the mapping between S_{i,j} and T_{x,y} may be a fixed arbitrary one-to-one mapping. However, in certain places such as boundaries, a pixel may not collect all the B₀×B₀ samples from its neighborhood. These pixels should converge to a correct result. Therefore, in some embodiments, each pixel also traverses the sequence through time. In some embodiments, the following formula may be used for relating S_{i,j} and T_{x,y}.

$$i = ⌊ \frac{{\tilde{C}}_{{B}_{0} \cdot x + y + t}}{{B}_{0}} ⌋ \\ j = {\tilde{C}}_{{B}_{0} \cdot x + y + t} mod {B}_{0} \qquad ( 8 )$$

Using this mapping, even if a pixel is only able to obtain a sample from itself, the pixel may still converge at B₀² times slower than ordinary samples.

Stratification in higher levels may still be needed, as typically the first level is very coarse. In some embodiments, the higher level samples are only accumulated through time. So there is not much difference from what is described in the section titled Hierarchical Grid Sampling. Employing unified sampling of different pixels may avoid low-frequency noise. In some embodiments, the sampling offset can be computed and used as a per-frame constant in the shaders.

### Filtering

Although the assumption was made that the diffuse indirect illumination is smooth and slow-varying, the geometric discontinuity may introduce hard edges in the shaded frame. Blindly filtering across these discontinuities may introduce artifacts. To address this problem, some embodiments may apply a bilateral filtering method similar to a joint bilateral filter.

Some embodiments of the filtering technique may differentiate pixels from the same and different geometric entities, and keep only the same ones for averaging. To achieve that, two thresholds, εₙ and ε_{z}, may be used on surface normal and ray distance (or depth) respectively. If the difference of either normal or ray distance of two samples is greater than its threshold, the samples are considered different and hence not mixed in the filtering. In some embodiments, the filtered pixel c_{i,j} may be computed as:

$${c}_{i , j}^{F} = \frac{{Σ}_{p} {Σ}_{q} {c}_{p , q} w ( \vert {n}_{p , q} - {n}_{i , j} \vert , {ɛ}_{n} ) w ( \vert {z}_{p , q} - {z}_{i , j} \vert , {ɛ}_{z} )}{{Σ}_{p} {Σ}_{q} w ( \vert {n}_{p , q} - {n}_{i , j} \vert , {ɛ}_{n} ) w ( \vert {z}_{p , q} - {z}_{i , j} \vert , {ɛ}_{z} )} \\ where \text{:} \\ w ( s , t ) = \{ \begin{matrix}0 : & s > t \\ 1 : & s \leq t\end{matrix} \qquad ( 9 )$$

Note that w(s, t) makes a binary decision. This could potentially lead to sudden changes in the filtered signal when some inputs are near the threshold. As an alternative, in some embodiments, a smooth function such as a Gaussian function may be used. However, a smooth function may introduce unwanted bias among perfectly valid samples. In some embodiments, a combination of the two may be used.

In at least some embodiments, if the joint bilateral filter does not provide a sufficient set of samples to cover the sampling space (i.e. the hemisphere) for pixels at geometry boundaries, additional rays may be fired accordingly to make up for the undersampled portion of the sampling space for these pixels. To be consistent with neighboring pixels, the additional rays may follow the same direction as the samples with low bilateral weights.

### Adaptive Sampling and Termination

With the bilateral filter, some of the samples from the neighborhood in screen space can be discarded because they are not from the same piece of geometry. In the interleaved sampling method, this may lead to insufficient coverage of the sampling hemisphere, causing visible noise. In some embodiments, from the value of the denominator in Equation 9, the number of valid neighboring samples that are collected for the current pixel may be obtained. If the number is less than B₀×B₀, this indicates that some of the sampling directions are missing. Typically, this happens near geometric discontinuities. In such a case, in some embodiments, more secondary rays may be fired in diverse directions for each pixel when computing the irradiance in order to compensate for the missing samples. This may help these pixels converge at roughly the same speed as other pixels.

In some regions, particularly in open areas without much shadow, pixels may converge relatively fast in a small number of iterations. It may be a waste of computational resources to continue calculating for these pixels. In some embodiments, such cases may be identified by estimating the local variance of each pixel in a recent time window. If the variance is small for a certain period of time or for a threshold number of iterations, the method may be relatively confident that the corresponding pixel has converged, and the iterations on this pixel may thus be stopped.

### Non-Adaptive and Adaptive Embodiments

As previously mentioned, non-adaptive and adaptive embodiments of the methods for progressive interleaved irradiance sampling may be provided. Examples of pseudocode for non-adaptive and adaptive embodiments are provided below. The pseudocode is given by way of example, and is not intended to be limiting. See FIG. 4 for data flow in a progressive interleaved irradiance sampling method according to some embodiments.

### Non-Adaptive Progressive Interleaved Irradiance Sampling

The following is example pseudocode for a global illumination rendering process using non-adaptive progressive interleaved irradiance sampling according to some embodiments. Comments are indicated by “//”:

// clear buffer for the results
Clear accumulation image;
// set up the iteration
looping = true;
iterationNumber = 0;
While (looping)
{

// Compute direct and indirect illumination and combine them into an
incremental image
Compute incremental image (with 1 sample per pixel);
Blend incremental image with accumulation image;
// The user may interrupt processing, e.g. if displayed results are
satisfactory
if (interrupted by user) looping = false;
// Stop iterating if a max number of iterations is reached
if (iterationNumber > maxIterations) looping = false;
iterationNumber++;

}

The following is example pseudocode for computing an incremental image according to some embodiments:

// for each pixel, only one secondary ray is fired
Generate one ray per pixel;
Intersect each ray with the scene geometry;
// See Figure 4
Compute surface diffuse color, irradiance, and non-irradiance (direct)

shading (including highlights, specular reflections, refractions),
surface depths and normals;

Use the surface depths and normals to filter the irradiance values with a
joint-bilateral filter;
Multiply the filtered irradiance value with the diffuse color and add it to

the non-irradiance shading (direct illumination), and use the result as
an incremental image;

The following is example pseudocode for blending the incremental image with the accumulation image according to some embodiments:
Compute blending weights b_{A} and b_{I} based on the iteration number;
Accumulation Image=b_{A}*(Accumulation Image)+b_{I}*(Incremental Image);

In some embodiments:
b_{I}=1.0f/(Iteration Number+1);
b_{A}=1.0f−b_{I};

In these embodiments, the image the image is normalized as it is accumulated.

In some embodiments:
b_{A}=1.0f;
b_{I}=1.0f;
   In these embodiments, the accumulation image may be divided by the iteration number before being used for output or satisfaction criteria.

### Adaptive Progressive Interleaved Irradiance Sampling

Embodiments of an adaptive method for progressive interleaved irradiance sampling renders the scene in blocks (e.g., a 16×16 block); some blocks may be rendered for more iterations than other blocks. In some embodiments, each block of pixels stores a state variable that marks the block as active, satisfied, or stopped, or the functional equivalent thereof.

In some embodiments, all blocks are initially marked as active. After a fixed number of iterations (for example, 16 iterations) has completed, a stopping criterion is computed at each subsequent iteration to see if a block of pixels is satisfied. A block that is active or satisfied has rays computed, but only active blocks are blended into the accumulation buffer. A block is marked complete if it and its immediate neighbors (e.g., 8 way neighbors) are all satisfied or complete.

In some embodiments, to decide whether a block is complete, the incremental image pixel value is compared to the accumulated image value. The absolute maximum difference divided by the square root of the iteration number is compared to a threshold. If less than the threshold, then the block is marked as satisfied. Variations of this technique may take image gradients into account (to avoid over-sampling crisp edges) or variances of pixel values based on a statistical model that stores information at each pixel location.

The following is example pseudocode for a global illumination rendering process using adaptive progressive interleaved irradiance sampling according to some embodiments. Comments are indicated by “//”:

// clear buffer for the results
Clear accumulation image;
// set up the iteration
looping = true;
iterationNumber = 0;
// initialize the state of the blocks
set all image blocks to active;
While (looping)
{

// process blocks to compute direct and indirect illumination and
// combine them into an incremental image
Compute incremental image (with 1 sample per pixel)
Blend incremental image with accumulation image;
// Process the state of the blocks
Compute the termination criterion for each block, and update block

states from active to satisfied accordingly;

Update satisfied blocks to stopped if they and 8-way neighbors are
satisfied or stopped;
// The user may interrupt processing, e.g. if displayed results are
satisfactory
if (interrupted by user) looping = false;
// Stop iterating if a max number of iterations is reached
if (iterationNumber > maxIterations) looping = false;
// Stop iterating if all blocks are stopped
if (all blocks are stopped) looping = false;
iterationNumber ++;

}

Computing an incremental image and blending the incremental image with the accumulation image may be implemented similar to the non-adaptive method, except that the image is rendered in blocks instead of as a whole.

### Results

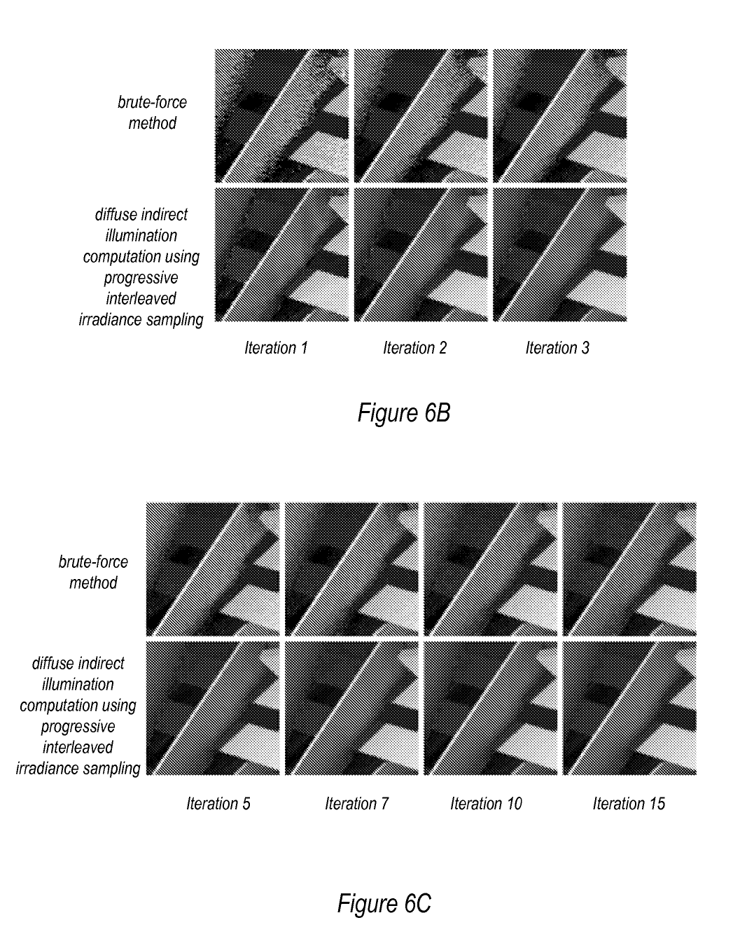

FIGS. 6A through 6C show a comparison of results of a conventional brute-force method for calculating irradiance that fires many secondary rays at each point and results of a method that includes diffuse indirect illumination computation using progressive interleaved irradiance sampling as described herein. FIG. 6A shows a sample image and a close-up of a region of the sample image that is processed by the two methods. Results of the methods are compared after iterations 1, 2, 3, 5, 7, 10, and 15 in FIGS. 6B and 6C. FIG. 6B shows the first three iterations, while FIG. 6B shows iterations 5, 7, 10 and 15. Unlike the conventional brute-force method, embodiments may not introduce low frequency noise, which is the cause of the blotchy artifacts visible in the results of the conventional method.

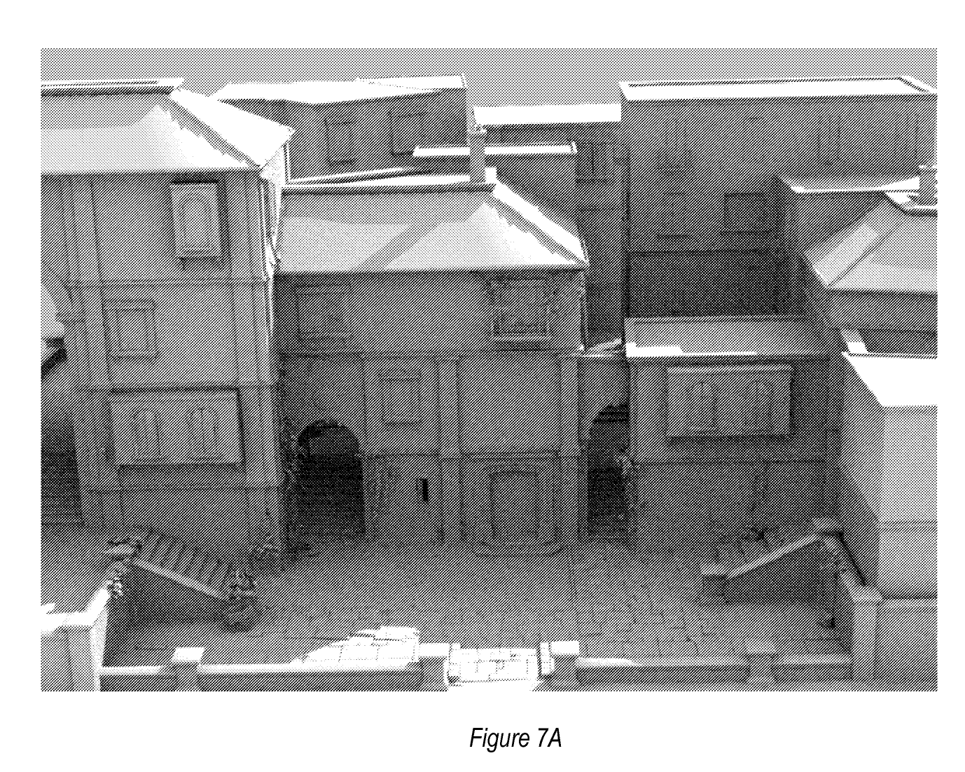

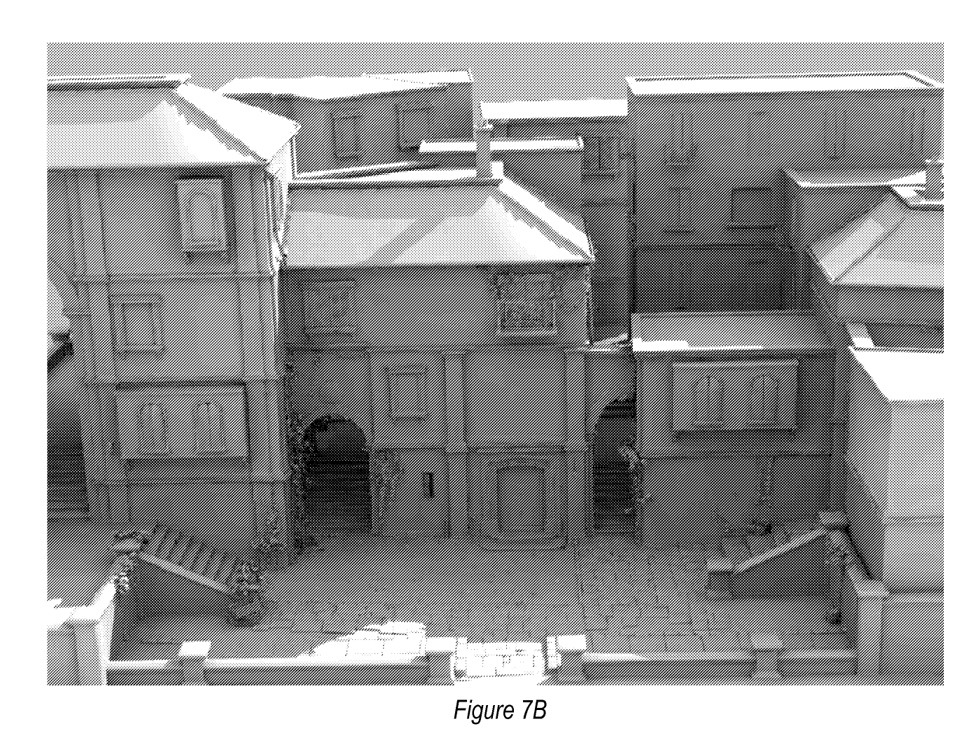

FIGS. 7A and 7B and FIGS. 8A and 8B compare results, after the same amount of time, of a conventional brute-force method for calculating irradiance that fires many secondary rays at each point with results of a method that includes diffuse indirect illumination computation using progressive interleaved irradiance sampling as described herein. FIGS. 7A and 8A show results of a conventional brute-force method on two sample images, and FIGS. 7B and 8B show results of the method for diffuse indirect illumination computation as described herein on the same two sample images, and after the same amount of time.

A possible problem with filtering methods is that, by attenuating the higher frequencies in the signal, bias may be introduced into the image in the form of blurring. In some embodiments of the progressive interleaved irradiance sampling method, sharp changes in the shading may be smoothed, to some extent, depending on the filter size that is used. Using embodiments of the progressive interleaved irradiance sampling method as described herein on most scenes, the bias is not very noticeable, while the overall perceived image quality is greatly improved when compared to results of conventional methods.

### Example Flowcharts and Implementations

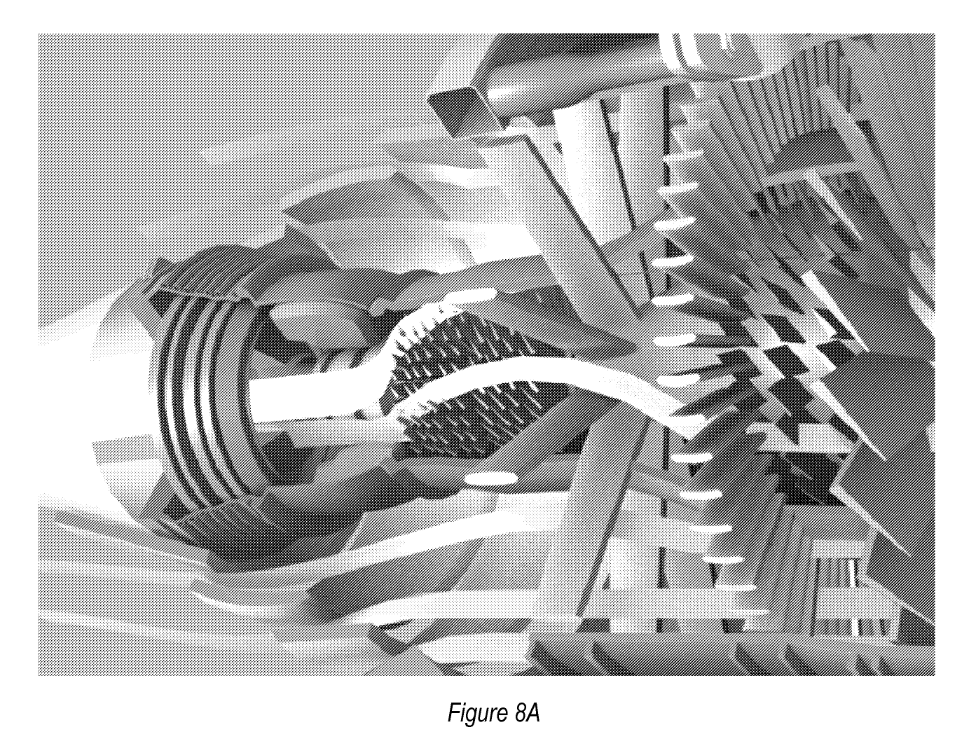

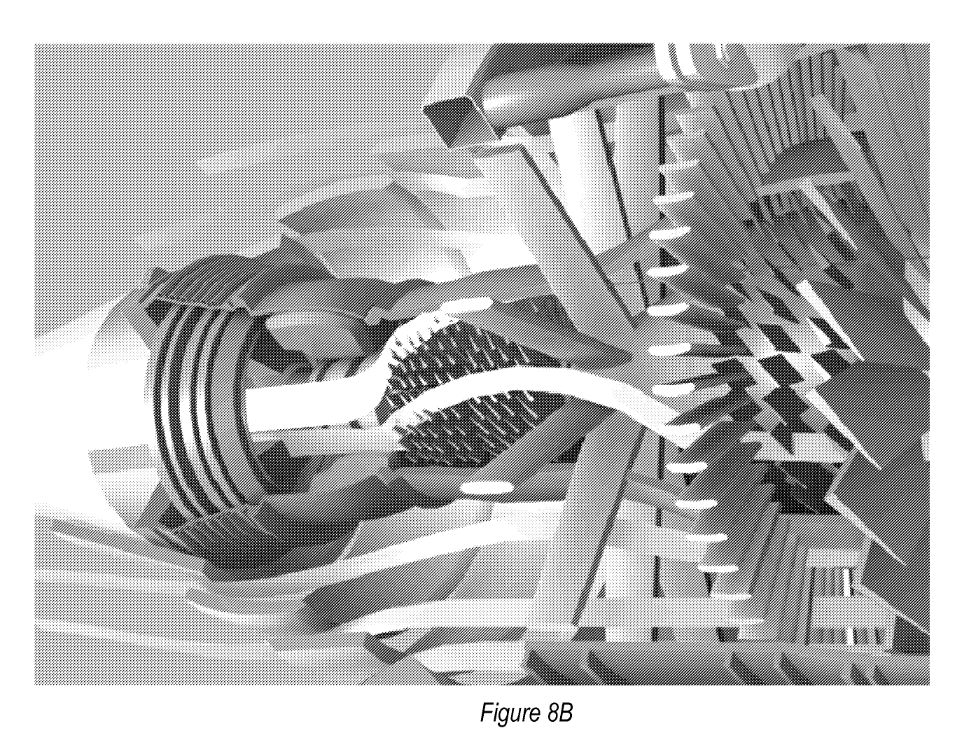

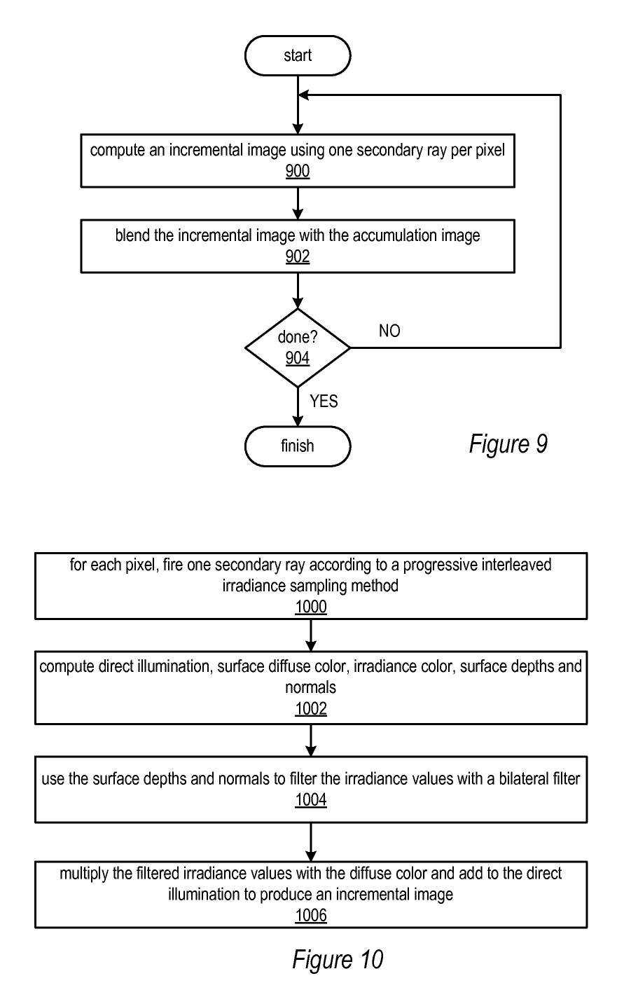

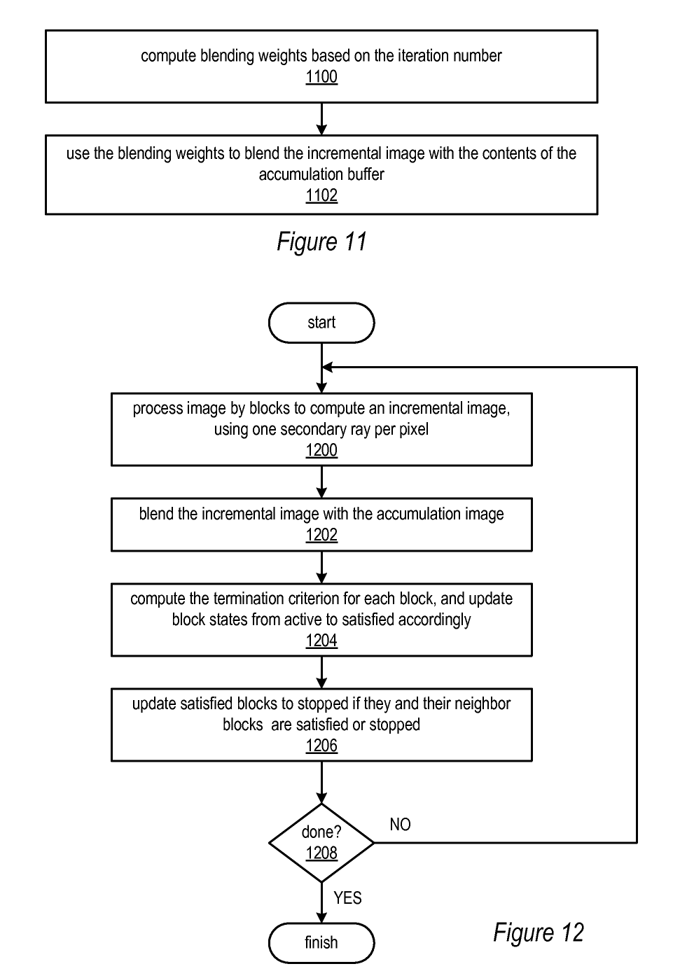

FIGS. 9 through 12 are flowcharts of methods for global illumination rendering that include diffuse indirect illumination computation using progressive interleaved irradiance sampling according to some embodiments. FIGS. 9 through 11 are flowcharts of a non-adaptive method according to some embodiments, and FIG. 12 is a flowchart of an adaptive method according to some embodiments. Note that FIGS. 10 and 11 show methods that may also be used to perform elements of FIG. 12.

FIG. 9 is a high-level flowchart of a global illumination rendering method using a non-adaptive diffuse indirect illumination method as described herein, according to some embodiments. As indicated at 900, an incremental image may be computed using one secondary ray per pixel. A progressive interleaved irradiance sampling method as describe herein may be used with or in a shader to determine where to fire a secondary ray at each pixel at each iteration. As indicated at 902, at each iteration, the incremental image may be blended with the accumulation image or buffer. The process iterates until a stopping criterion is met, as indicated at 904. For example, in some embodiments, a user may stop the rendering when displayed results (the current content of the accumulation buffer) are satisfactory. As another example, a parameter or constant may indicate a maximum number of iterations to be performed.

FIG. 10 is a flowchart of a method for performing element 900 of FIG. 9 according to some embodiments. The method of FIG. 10 may also be used in performing element 1200 of FIG. 12. As indicated at 1000, for each pixel, one secondary ray is fired, for example according to a progressive interleaved irradiance sampling method as described herein. As indicated at 1002, direct illumination, surface diffuse color, irradiance, surface depths and normals are computed at each pixel according to the fired secondary ray. As indicated at 1004, the surface depths and normals are used to filter the irradiance values according to a bilateral filter. In some embodiments, a joint-bilateral filter may be used. In some embodiments, the kernel size of the bilateral filter may be decreased over iterations; that is, the size of the filter may be reduced over time. As indicated at 1006, the filtered irradiance values may be multiplied with the diffuse color, and the results combined with the direct illumination to produce an incremental image.

FIG. 11 is a flowchart of a method for performing element 902 of FIG. 9 according to some embodiments. The method of FIG. 11 may also be used in performing element 1202 of FIG. 12. As indicated at 1100, blending weights may be computed based on the iteration number. As indicated at 1102, the blending weights may then be used to blend the incremental image with the contents of the accumulation buffer. The accumulation buffer may then be displayed. Note that, in some embodiments, the accumulation buffer may not be displayed.

FIG. 12 is a flowchart of a global illumination rendering method using an adaptive diffuse indirect illumination method as described herein, according to some embodiments. In the adaptive method, the image is processed in blocks. All the blocks are initialized to active. As indicated at 1200, an incremental image may be computed using one secondary ray per pixel. The image is processed by blocks; blocks for which processing has been stopped on a previous iteration are not processed. A progressive interleaved irradiance sampling method as describe herein may be used with or in a shader to determine where to fire a secondary ray at each pixel at each iteration. A method of processing pixels for element 1200 is illustrated in FIG. 10. As indicated at 1202, at each iteration, the incremental image may be blended with the accumulation image or buffer. In some embodiments, only blocks that were processed during the current iteration are blended. A method of processing for element 1202 is illustrated in FIG. 11. As indicated at 1204, the termination criterion for each block is computed, and block states may be changed from active to satisfied accordingly. As indicated at 1206, the state of satisfied blocks is checked; a block may be changed from satisfied to stopped if the block and its neighbor blocks (e.g., its eight adjacent blocks) are all satisfied or stopped. The process iterates until a stopping criterion is met, as indicated at 1208. For example, in some embodiments, a user may stop the rendering when displayed results (the current content of the accumulation buffer) are satisfactory. As another example, a parameter or constant may indicate a maximum number of iterations to be performed. As another example, the process may stop when all blocks are marked as stopped.

In various embodiments, the methods for global illumination rendering using diffuse indirect illumination computation using progressive interleaved irradiance sampling as described above may be implemented in a global illumination rendering module. FIG. 13 illustrates an example global illumination rendering module that may implement a global illumination rendering method according to the methods describe herein. Global illumination rendering module 1300 may include a shader 1304 or similar component that handles firing a single secondary ray per pixel, for example according to a sampling method as described herein, to calculate irradiance (prior to filtering), normal/depth values, diffuse color, and direct lighting (see, e.g., FIG. 4). Global illumination rendering module 1300 may also include an indirect illumination component 1306 that computes indirect illumination from output of shader 1304 as described above. In some embodiments, module 1300 may provide a user interface 1302 that includes one or more user interface elements via which a user may initiate, interact with, direct, and/or control the global illumination rendering process. Module 1300 may obtain an input image 1320 or region of an image and, optionally, user input 1322, iteratively compute direct illumination 1308 and indirect illumination 1310 for the image firing one secondary ray per pixel, combine the direct illumination 1308 and indirect illumination 1310 into an incremental image 1312, and blend the incremental image into an accumulation buffer 1314. This process may be repeated or iterated to generate frames until a stopping criterion is met. When done, an output image 1330 may be generated from the accumulation buffer 1314. The output image 1330 may, for example, be stored to a storage device and/or displayed to a display device. In some embodiments, the user interface may provide one or more user interface elements whereby the user may stop iterations of the global illumination rendering method, for example if the displayed results are satisfactory.

Global illumination rendering module 1300 may be implemented as or in a stand-alone application or as a module of or plug-in for a graphics application or graphics library that may provide other graphical/digital image processing tools. Examples of types of applications in which embodiments of module 1300 may be implemented may include, but are not limited to, scientific, medical, design (e.g., CAD systems), painting, publishing, digital photography, video editing, games, animation, and/or other applications in which digital image processing may be performed. Specific examples of applications in which embodiments may be implemented include, but are not limited to, Adobe® Photoshop® and Adobe® After Effects®.

In some embodiments, some or all components of global illumination rendering module 1300 may be implemented on or in a graphics processing unit (GPU). In some embodiments, in addition to generating output image 1330, module 1300 may be used to display, manipulate, modify, and/or store the output image, for example to a memory medium such as a storage device or storage medium.

### Example System

Embodiments of a global illumination rendering module as described above may be executed on one or more computer systems, which may interact with various other devices. One such computer system is illustrated by FIG. 14. In different embodiments, computer system 1400 may be any of various types of devices, including, but not limited to, a personal computer system, desktop computer, laptop, notebook, or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In the illustrated embodiment, computer system 1400 includes one or more processors 1410 coupled to a system memory 1420 via an input/output (I/O) interface 1430. Computer system 1400 further includes a network interface 1440 coupled to I/O interface 1430, and one or more input/output devices 1450, such as cursor control device 1460, keyboard 1470, and display(s) 1480. In some embodiments, it is contemplated that embodiments may be implemented using a single instance of computer system 1400, while in other embodiments multiple such systems, or multiple nodes making up computer system 1400, may be configured to host different portions or instances of embodiments. For example, in one embodiment some elements may be implemented via one or more nodes of computer system 1400 that are distinct from those nodes implementing other elements.

In various embodiments, computer system 1400 may be a uniprocessor system including one processor 1410, or a multiprocessor system including several processors 1410 (e.g., two, four, eight, or another suitable number). Processors 1410 may be any suitable processor capable of executing instructions. For example, in various embodiments, processors 1410 may be general-purpose or embedded processors implementing any of a variety of instruction set architectures (ISAs), such as the x86, PowerPC, SPARC, or MIPS ISAs, or any other suitable ISA. In multiprocessor systems, each of processors 1410 may commonly, but not necessarily, implement the same ISA.

In some embodiments, at least one processor 1410 may be a graphics processing unit. A graphics processing unit or GPU may be considered a dedicated graphics-rendering device for a personal computer, workstation, game console or other computing or electronic device. Modern GPUs may be very efficient at manipulating and displaying computer graphics, and their highly parallel structure may make them more effective than typical CPUs for a range of complex graphical algorithms. For example, a graphics processor may implement a number of graphics primitive operations in a way that makes executing them much faster than drawing directly to the screen with a host central processing unit (CPU). In various embodiments, the illumination rendering methods disclosed herein may, at least in part, be implemented by program instructions configured for execution on one of, or parallel execution on two or more of, such GPUs. The GPU(s) may implement one or more application programmer interfaces (APIs) that permit programmers to invoke the functionality of the GPU(s). Suitable GPUs may be commercially available from vendors such as NVIDIA Corporation, ATI Technologies (AMD), and others.

System memory 1420 may be configured to store program instructions and/or data accessible by processor 1410. In various embodiments, system memory 1420 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing desired functions, such as those described above for embodiments of a global illumination rendering module are shown stored within system memory 1420 as program instructions 1425 and data storage 1435, respectively. In other embodiments, program instructions and/or data may be received, sent or stored upon different types of computer-accessible media or on similar media separate from system memory 1420 or computer system 1400. Generally speaking, a computer-accessible medium may include storage media or memory media such as magnetic or optical media, e.g., disk or CD/DVD-ROM coupled to computer system 1400 via I/O interface 1430. Program instructions and data stored via a computer-accessible medium may be transmitted by transmission media or signals such as electrical, electromagnetic, or digital signals, which may be conveyed via a communication medium such as a network and/or a wireless link, such as may be implemented via network interface 1440.

In one embodiment, I/O interface 1430 may be configured to coordinate I/O traffic between processor 1410, system memory 1420, and any peripheral devices in the device, including network interface 1440 or other peripheral interfaces, such as input/output devices 1450. In some embodiments, I/O interface 1430 may perform any necessary protocol, timing or other data transformations to convert data signals from one component (e.g., system memory 1420) into a format suitable for use by another component (e.g., processor 1410). In some embodiments, I/O interface 1430 may include support for devices attached through various types of peripheral buses, such as a variant of the Peripheral Component Interconnect (PCI) bus standard or the Universal Serial Bus (USB) standard, for example. In some embodiments, the function of I/O interface 1430 may be split into two or more separate components, such as a north bridge and a south bridge, for example. In addition, in some embodiments some or all of the functionality of I/O interface 1430, such as an interface to system memory 1420, may be incorporated directly into processor 1410.

Network interface 1440 may be configured to allow data to be exchanged between computer system 1400 and other devices attached to a network, such as other computer systems, or between nodes of computer system 1400. In various embodiments, network interface 1440 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 1450 may, in some embodiments, include one or more display terminals, keyboards, keypads, touchpads, scanning devices, voice or optical recognition devices, or any other devices suitable for entering or retrieving data by one or more computer system 1400. Multiple input/output devices 1450 may be present in computer system 1400 or may be distributed on various nodes of computer system 1400. In some embodiments, similar input/output devices may be separate from computer system 1400 and may interact with one or more nodes of computer system 1400 through a wired or wireless connection, such as over network interface 1440.

As shown in FIG. 14, memory 1420 may include program instructions 1425, configured to implement embodiments of a global illumination rendering module as described herein, and data storage 1435, comprising various data accessible by program instructions 1425. In one embodiment, program instructions 1425 may include software elements of embodiments of a global illumination rendering module as illustrated in the above Figures. Data storage 1435 may include data that may be used in embodiments. In other embodiments, other or different software elements and data may be included.

Those skilled in the art will appreciate that computer system 1400 is merely illustrative and is not intended to limit the scope of a global illumination rendering module as described herein. In particular, the computer system and devices may include any combination of hardware or software that can perform the indicated functions, including a computer, personal computer system, desktop computer, laptop, notebook, or netbook computer, mainframe computer system, handheld computer, workstation, network computer, a camera, a set top box, a mobile device, network device, internet appliance, PDA, wireless phones, pagers, a consumer device, video game console, handheld video game device, application server, storage device, a peripheral device such as a switch, modem, router, or in general any type of computing or electronic device. Computer system 1400 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1400 may be transmitted to computer system 1400 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Accordingly, the present invention may be practiced with other computer system configurations.

### CONCLUSION

Various embodiments may further include receiving, sending or storing instructions and/or data implemented in accordance with the foregoing description upon a computer-accessible medium. Generally speaking, a computer-accessible medium may include storage media or memory media such as magnetic or optical media, e.g., disk or DVD/CD-ROM, volatile or non-volatile media such as RAM (e.g. SDRAM, DDR, RDRAM, SRAM, etc.), ROM, etc., as well as transmission media or signals such as electrical, electromagnetic, or digital signals, conveyed via a communication medium such as network and/or a wireless link.

The various methods as illustrated in the Figures and described herein represent example embodiments of methods. The methods may be implemented in software, hardware, or a combination thereof. The order of method may be changed, and various elements may be added, reordered, combined, omitted, modified, etc.

Various modifications and changes may be made as would be obvious to a person skilled in the art having the benefit of this disclosure. It is intended that the invention embrace all such modifications and changes and, accordingly, the above description to be regarded in an illustrative rather than a restrictive sense.

1. A method, comprising:
rendering, by one or more computing devices, global illumination for an input three-dimensional image of a scene, wherein said rendering comprises:
computing direct illumination and indirect illumination for the three-dimensional image, wherein, in said computing, a single secondary ray is fired from each pixel to calculate direct illumination values and indirect illumination values at the pixels;
combining the computed direct illumination and the computed indirect illumination to generate an incremental image;
blending the incremental image into an accumulation image; and
repeating said computing, said combining, and said blending until determining that at least one of one or more stopping criteria is satisfied; and
generating an output three-dimensional image of the scene according to the accumulation image.

2. The method as recited in claim 1, wherein said computing direct illumination and indirect illumination for the image comprises:
for each pixel in the image, calculating an initial irradiance value, a surface diffuse color value, and the direct illumination value for the respective pixel according to the single secondary ray;
applying a filter to the initial irradiance values to generate filtered irradiance values; and
combining the filtered irradiance values with the surface diffuse color values to generate the indirect illumination values for the pixels.

3. The method as recited in claim 2, wherein the filter is a joint-bilateral filter.

4. The method as recited in claim 2, wherein said computing direct illumination and indirect illumination for the image further comprises, for each pixel in the image, calculating a surface depth value and a surface normal value at each pixel according to the single secondary ray, and wherein, in said applying a filter, the method further comprises using the surface depths and the surface normals for the pixels to filter the initial irradiance values for respective pixels according to a bilateral filter.

5. The method as recited in claim 1, wherein said computing direct illumination and indirect illumination for the three-dimensional image comprises applying an incremental stratified grid sampling technique to determine in which direction each secondary ray is fired, wherein the incremental stratified grid sampling technique fires the secondary rays in different directions at each pixel on each iteration according to a sampling sequence so that each pixel receives a relatively uniform coverage of irradiance samples from an integrated hemisphere relative to the pixel.

6. The method as recited in claim 1, wherein said computing direct illumination and indirect illumination for the three-dimensional image comprises, at each iteration, firing the secondary ray in a different direction at each pixel so that each pixel receives a relatively uniform coverage of irradiance samples from an integrated hemisphere relative to the pixel.

7. The method as recited in claim 1, further comprising dividing the image into a plurality of blocks, wherein said computing, said combining, and said blending are performed separately for each block.

8. The method as recited in claim 7, wherein at least one block is processed for more iterations than at least one other block.

9. A system, comprising:
at least one processor; and
a memory comprising program instructions, wherein the program instructions are executable by the at least one processor to:
render global illumination for an input three-dimensional image of a scene, wherein, to render global illumination, the program instructions are executable by the at least one processor to:
compute direct illumination and indirect illumination for the three-dimensional image, wherein, in said compute, a single secondary ray is fired from each pixel to calculate direct illumination values and indirect illumination values at the pixels;
combine the computed direct illumination and the computed indirect illumination to generate an incremental image;
blend the incremental image into an accumulation image; and
repeat said compute, said combine, and said blend until determining that at least one of one or more stopping criteria is satisfied; and
generate an output three-dimensional image of the scene according to the accumulation image.

10. The system as recited in claim 9, wherein, to compute direct illumination and indirect illumination for the image, the program instructions are executable by the at least one processor to:
for each pixel in the image, calculate an initial irradiance value, a surface diffuse color value, and the direct illumination value for the respective pixel according to the single secondary ray;
apply a filter to the initial irradiance values to generate filtered irradiance values; and
combine the filtered irradiance values with the surface diffuse color values to generate the indirect illumination values for the pixels.

11. The system as recited in claim 10, wherein, to compute direct illumination and indirect illumination for the image, the program instructions are executable by the at least one processor to, for each pixel in the image, calculate a surface depth value and a surface normal value at each pixel according to the single secondary ray, and wherein, to apply a filter, the program instructions are executable by the at least one processor to use the surface depths and the surface normals to filter the initial irradiance values for respective pixels according to a bilateral filter.

12. The system as recited in claim 9, wherein, to compute direct illumination and indirect illumination for the image, the program instructions are executable by the at least one processor to apply an incremental stratified grid sampling technique to determine in which direction each secondary ray is fired, wherein the incremental stratified grid sampling technique fires the secondary rays in different directions at each pixel on each iteration according to a sampling sequence so that each pixel receives a relatively uniform coverage of irradiance samples from an integrated hemisphere relative to the pixel.

13. The system as recited in claim 9, where the program instructions are executable by the at least one processor to divide the image into a plurality of blocks, wherein said computing, said combining, and said blending are performed separately for each block.

14. The system as recited in claim 13, wherein the program instructions are executable by the at least one processor to process at least one block for more iterations than at least one other block.

15. A non-transitory computer-readable storage medium storing program instructions, wherein the program instructions are computer-executable to implement:
rendering, by one or more computing devices, global illumination for an input three-dimensional image of a scene, wherein said rendering comprises:
computing direct illumination and indirect illumination for the three-dimensional image, wherein, in said computing, a single secondary ray is fired from each pixel to calculate direct illumination values and indirect illumination values at the pixels;
combining the computed direct illumination and the computed indirect illumination to generate an incremental image;
blending the incremental image into an accumulation image; and
repeating said computing, said combining, and said blending until determining that at least one of one or more stopping criteria is satisfied; and
generating an output three-dimensional image of the scene according to the accumulation image.

16. The non-transitory computer-readable storage medium as recited in claim 15, wherein, in said computing direct illumination and indirect illumination for the image, the program instructions are computer-executable to implement:
for each pixel in the image, calculating an initial irradiance value, a surface diffuse color value, and the direct illumination value for the respective pixel according to the single secondary ray;
applying a filter to the initial irradiance values to generate filtered irradiance values; and
combining the filtered irradiance values with the surface diffuse color values to generate the indirect illumination values for the pixels.

17. The non-transitory computer-readable storage medium as recited in claim 16, wherein, in said computing direct illumination and indirect illumination for the image, the program instructions are computer-executable to implement, for each pixel in the image, calculating a surface depth value and a surface normal value at each pixel according to the single secondary ray, and wherein, in said applying a filter, the program instructions are computer-executable to implement using the surface depths and the surface normals to filter the initial irradiance values for respective pixels according to a bilateral filter.

18. The non-transitory computer-readable storage medium as recited in claim 15, wherein, in said computing direct illumination and indirect illumination for the image, the program instructions are computer-executable to implement applying an incremental stratified grid sampling technique to determine in which direction each secondary ray is fired, wherein the incremental stratified grid sampling technique fires the secondary rays in different directions at each pixel on each iteration according to a sampling sequence so that each pixel receives a relatively uniform coverage of irradiance samples from an integrated hemisphere relative to the pixel.

19. The non-transitory computer-readable storage medium as recited in claim 15, wherein the program instructions are computer-executable to implement dividing the image into a plurality of blocks, wherein said computing, said combining, and said blending are performed separately for each block.

20. The non-transitory computer-readable storage medium as recited in claim 19, wherein at least one block is processed for more iterations than at least one other block.
